(19) United States
(12) Patent Application Publication
(10) Pub. No.: US 2005/0137881 A1
(43) Pub. Date: Jun. 23, 2005

(54) Method for generating and embedding vocal performance data into a music file format

(75) Inventors: Thomas Alexander Bellwood, Austin, TX (US); Robert Bryant Chumbley, Austin, TX (US); Matthew Francis Rutkowski, Pflugerville, TX (US); Lawrence Frank Weiss, Round Rock, TX (US)

Correspondence Address: IBM CORPORATION (CS);C/O CARR LLP, 670 FOUNDERS SQUARE, 900 JACKSON STREET, DALLAS, TX, 75202, US

(73) Assignee: International Business Machines Corporation, Armonk, NY (US)

(21) Appl. No.: 10/738,718

(22) Filed: Dec. 17, 2003

(51) Int. Cl. G06F 17/28

(52) U.S. Cl. 704/277

(57) ABSTRACT

A method, an apparatus, and a computer program are provided for embedding enhancement data into lyrics to generate Enhanced Symbolic Phonetic Representation (ESPR) data file that incorporates symbolic representations of actions that are associated with singing, such as sustaining and vibrato. The ESPR includes data for singing by a human voice or chorus of voices. The lyrics can also be inputting into a processing system in a variety of formats, such as plain text or a Symbolic Phonetic Representation (SPR).

### CROSS-REFERENCED APPLICATIONS

This application relates to co-pending U.S. Patent Applications entitled “ESPR DRIVEN TEXT-TO-SONG ENGINE” by Bellwood et al. (Docket No. AUS920030800US1), filed concurrently herewith.

### BACKGROUND OF THE INVENTION

1. Technical Field

The present invention relates generally to the operation of music support files and, more particularly, to the utilization of a vocal channel within a music support file.

2. Description of the Related Art

In 1983, musical instrument synthesizer manufacturers introduced an electronic format that greatly assisted in operation of synthesizers, the Music Instrument Digital Interface (MIDI) file format. MIDIs, though, are not limited to synthesizers. There are a variety of other devices that utilize MIDIs. For example, studio recording equipment and karaoke machines utilize MIDIs. Moreover, there are a variety of other music support file formats that can be utilized in addition to the MIDI. The MIDI file format, though, is the most well known of the music support file formats.

The MIDI format, as perhaps other music support file formats, are control files that describe time based instructions or events that can be read and sent to MIDI a processor. The instructions can include the note, duration, accent, and other playback information. Instructions can be grouped as “channels” that are mapped to suggested playback instruments.

Once the instructions are received, the processor correlates the instructions to the desired instrument and outputs sound because the processor contains samples of or a mathematical model of the given musical instruments. The MIDI file also supports global settings for tempo, volume, performance style, and other variables that apply to all channels or on the individual instruction events.

Typically, MIDI files utilize multiple channels, one for each instrument. For a general MIDI processor, there are approximately 128 channels, wherein each channel can correspond up to 128 different instruments. However, MIDI processors can have more or less than 128 channels. In essence then, a MIDI and other music support files operate as sheet music while the processor operates as an orchestra. Thus far, though, there has been one performance instrument that the MIDIs, other music support file formats, and processors have not incorporated into their electronic orchestra, the human voice.

To date, MIDIs, other music support file formats, and processors have only made correlations between a “note” and a recorded sound. There has not yet been a computer or a synthesizer where one could sit down at a keyboard, play a song and hearing a voice or chorus emanating from the speakers incorporating all the inflections, crescendos, etc.

Therefore, there is a need for a method and/or apparatus for creating and utilizing a music support data incorporating a singing voice or chorus that addresses at least some of the problems associated with convention methods and apparatuses associated with music support file formats.

### SUMMARY OF THE INVENTION

The present invention provides a method and an apparatus for embedding enhanced phonetic data into a computer recognizable representation by a processor. If inputted linguistical data is at least configured to have embedded phonetic representations, phonetic representations of the linguistical data is derived. Associations between phonetic representations of the linguistical data and musical data to generate the enhanced phonetic data are provided.

### BRIEF DESCRIPTION OF THE DRAWINGS

For a more complete understanding of the present invention and the advantages thereof, reference is now made to the following descriptions taken in conjunction with the accompanying drawings, in which:

FIG. 1 is a block diagram depicting an encoding system;

FIG. 2 is a flow chart of the operation of an encoding system depicting a method for encoding a music support file from plain text;

FIG. 3 is a flow chart of the operation of an encoding system depicting a method for encoding a music support file from Symbolic Phonetic Representation (SPR); and

FIG. 4 is a flow chart of the operation of an encoding system depicting a method for encoding a music support file from Enhanced SPR (ESPR).

### DETAILED DESCRIPTION

In the following discussion, numerous specific details are set forth to provide a thorough understanding of the present invention. However, those skilled in the art will appreciate that the present invention can be practiced without such specific details. In other instances, well-known elements have been illustrated in schematic or block diagram form in order not to obscure the present invention in unnecessary detail. Additionally, for the most part, details concerning network communications, electromagnetic signaling techniques, and the like, have been omitted inasmuch as such details are not considered necessary to obtain a complete understanding of the present invention, and are considered to be within the understanding of persons of ordinary skill in the relevant art.

It is further noted that, unless indicated otherwise, all functions described herein can be performed in either hardware or software, or some combination thereof. In a preferred embodiment, however, the functions are performed by a processor such as a computer or an electronic data processor in accordance with code such as computer program code, software, and/or integrated circuits that are coded to perform such functions, unless indicated otherwise.

In the remainder of this description, a processing unit (PU) can be a sole processor of computations in a device. In such a situation, the PU is typically referred to as an MPU (main processing unit). The processing unit can also be one of many processing units that share the computational load according to some methodology or algorithm developed for a given computational device. For the remainder of this description, all references to processors shall use the term MPU whether the MPU is the sole computational element in the device or whether the MPU is sharing the computational element with other MPUs, unless indicated otherwise.

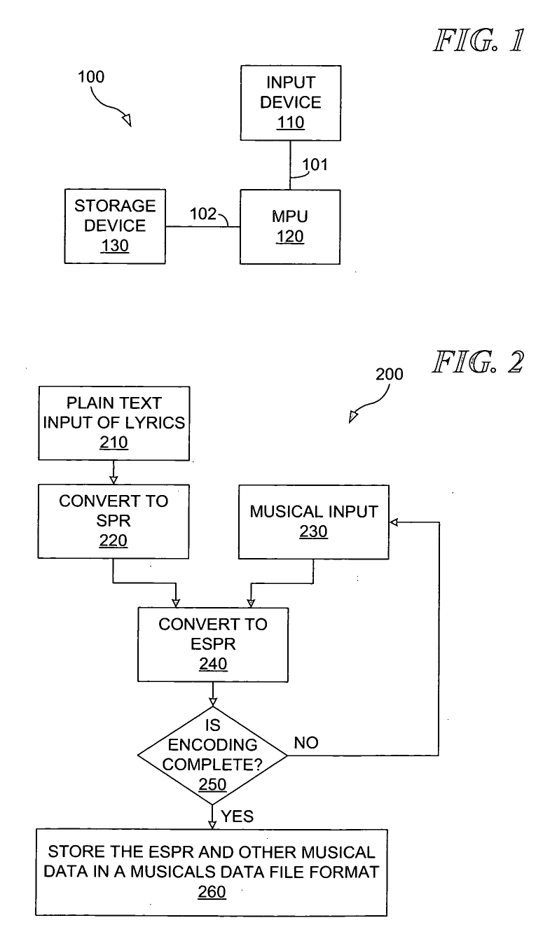

Referring to FIG. 1 of the drawings, the reference numeral 100 generally designates an encoding system utilized for an embedding ESPR data into a music file format. The encoding system 100 comprises an input device 110, an MPU 120, a storage device 130.

Generally, the encoding system 100 operates based on the use of SPR data that is further encoded with musical representations to yield ESPR data. SPR is a phonetic representation of words for use in computer systems, more particularly voice recognition systems and voice output systems. For example, ViaVoice™ uses an SPR system. However, there are a variety of software packages that utilize a variety of phonetic representations. These software packages operate by creating a correspondence between phonetic voice data and a table of sampled voice segments or voice algorithms to create or synthesize vocal output.

However, the encoding system 100 can operate on SPR data or ESPR data. There are three categories of enhancements to the SPR data to yield the ESPR data: musical data, performance data, and other data.

With the musical data enhancements, the ESPR data includes several symbolic representations that are more closely related to vocalizations associated with music in addition to other phonetic representations normally associated with SPR data. A variety of symbolic representations more closely related to singing can be added to SPR data to yield ESPR data. For example, notes, control of length of time segments to allow for a dynamic tempo and control of periods of rests can be added. Also, there can be symbolic representation for the sustaining of voiced parts of words in expressed time segments and for vibratos. Symbolic information relating to volume or intensity can also be added that would allow for specific representation of crescendos and the like. There are a variety of enhancements that correspond to a variety of well-known musical notations and representations that can be utilized.

Moreover, with the performance data enhancements, symbolic control values for a specific vocalization can be included to express melodic behavior of the vocalizations defining varying singing styles. More particularly, ESPR data can contain indicators that identify a particular vocalist uniquely. For example, the ESPR can contain an indicator identifying the singing style of Maria Callas or of Aretha Franklin. Also, Environment Modeling Annotations can be added to account for the specific venue upon which a given vocalization occurs, like reverb. There are a variety of enhancements that correspond to a variety of performance notations and representations that can be utilized.

With the other data enhancements, a variety of other control data is incorporated into the ESPR data. More particularly, the other data enhancements can allow for the instructions corresponding to storage, to streaming, or to processing. For example, the other data enhancements can include data that embeds the file as a MIDI file.

More particularly, when the ESPR data is embedded as a MIDI file, the ESPR data can have characteristics that correspond to MIDI. Firstly, the ESPR data embedded into a MIDI file can be encoded as one or more lyrical events. Also, existing MIDI processors will be able to process a MIDI file with the embedded ESPR data. In other words, an existing MIDI processor will be able to perform all of the music in the MIDI, but the MIDI processor may not necessarily be able to interpret the vocal performance. The recognition of embedded ESPR is accomplished through the use of a control sequence or header that indicates ESPR as part of a lyrical event. Also, the control sequence can indicate a corresponding channel with additional musical data that allows for ESPR performance. This corresponding channel can be a subset of the ESPR data for the purpose of correlation. There is a variety of other control data that can be embedded into a control sequence or header, and the above mentioned examples are meant for the purposes of illustration. Moreover, similar correlations and embedding procedures can be accomplished with a variety of other musical file formats.

The input device 110 encompasses a variety of input devices. Through the input device 110, data can be uploaded onto the encoding system 100 or keyed into the encoding system 100. For example, a keyboard, mouse, or synthesizer keyboard can be utilized to input desired musical notation. Also, the input device 110 is coupled to the MPU 120 through a first communication channel 101. Moreover, any of the aforementioned communications channels through a network configuration would encompass wireless links, packet switched channels, direct communication channels and any combination of the three.

The MPU 120 can be a variety of processors. The MPU 120 receives the data from the input device 110 and encodes the data into ESPR data. For example, a general-purpose computer or a dedicated musical composition computer can be utilized to encode as desired in ESPR format. Moreover, the MPU 120 is the component most responsible for correlating and encoding, specifically with one or more human voices singing, from a given, desired algorithm into ESPR format. Hence, the MPU 120 is responsible for generating the ESPR format from varying types of input.

The storage device 130 can encompass a variety of devices, such as a Hard Disk Drive (HDD). The storage device 130 stores the initial input to be encoded from the input device 110 and the encoded ESPR data. Moreover, the MPU 120 can receive information from storage (as shown), transfer though a communications network, or any combination of the two. Also, the storage device 130 is coupled to the MPU 120 through a second communication channel 102. Moreover, any of the aforementioned communications channels through a network configuration would encompass wireless links, packet switched channels, direct communication channels and any combination of the three.

Now referring to FIG. 2 of the drawings, the reference numeral 200 generally designates a flow chart of the operation of an encoding system depicting a method for encoding a music support file from plain text.

The inputting of plain text is back-end intensive. In other words, the processes to convert a plain text file to an ESPR format by the MPU 120 of FIG. 1 are extensive. There is an extensive requirement of matching the lyrical text specifically to a given song so as to have a proper output in ESPR format.

In step 210, the plain text is input through an input device 110 of FIG. 1. There are a variety of manners to input the plain text, and the examples contained herein are not intended to limit the manner in which data is input. For example, a text document can be uploaded to the MPU 120 of FIG. 1. Also, the plain text can be keyed in through a synthesizer, keyboard, or another type of input device.

In step 220, the plain text is converted into SPR by the MPU 120 of FIG. 1. There are a variety of SPR formats and conversion techniques that can be utilized, and the examples contained herein are not intended to limit the manner or format in which plain text is converted to SPR. For example, software, such as ViaVoice™, can convert plain text English into a British SPR.

In step 230, musical data is input. There are a variety of manners to input the musical data, and the examples contained herein are not intended to limit the manner in which musical data is input. For example, the musical data can also be keyed in through a synthesizer, keyboard, or another type of input device.

In step 240, the musical data and the SPR are converted by an MPU 120 of FIG. 1. The musical data and the SPR are converted to an ESPR data and tied to a channel. The desired vocalization may not necessarily have to singularly be tired to a channel. There can be a correlation between a given instrument and the vocalization, or there can be multiple, competing vocalizations by different voices. Moreover, the vocalization does not necessarily have to be a single voice, but can represent a chorus of voices as well. In the most extreme case, the music file data may contain only vocalizations represented by ESPR, that is to say, an “a capella” performance of a single voice, multiple voices, or a chorus. Also, there can be a correlation between a given instrument channel and ESPR data when the ESPR data relies on the instrument channel to provide some of the performance information. Multiple sets of ESPR data (representing different voices) can be tied to the same or different instrument channels. Moreover, a set of ESPR data does not necessarily have to be a single voice, but a chorus of voices as well.

In step 250, the user is prompted to determine if the conversion to ESPR is complete. At this step, the user can make a variety of changes to the ESPR. For example, the user can change the singer. There are a variety of changes that can be made, and the examples contained herein are not intended to limit the manner in which the ESPR can be changed.

In step 260, the ESPR and other musical data are stored. There are a variety of file formats that can be utilized. For example, the MIDI file format can be used. Also, there are a variety of well-known methods to store the converted file with the embedded ESPR data. For example, an HDD can be utilized. Moreover, the MPU 120 of FIG. 1 can transfer information directly to storage (as shown), transfer though a communications network, or any combination of the two.

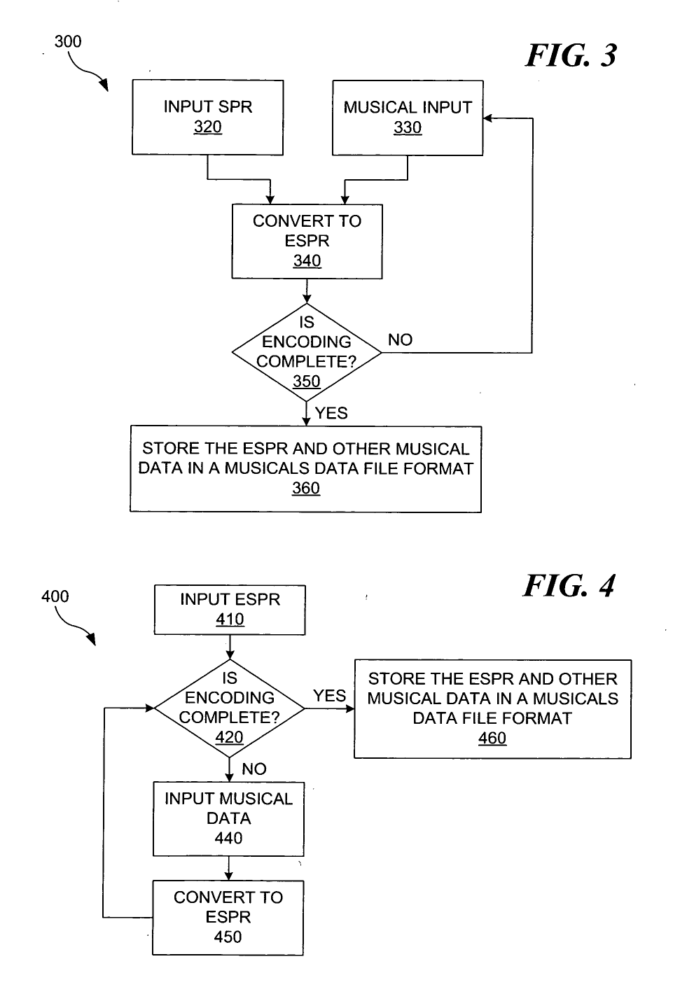

Now referring to FIG. 3 of the drawings, the reference numeral 300 generally designates a flow chart of depicting a method for embedding EPSR data derived from SPR and musical data into a music file format.

The inputting of SPR is less back-end intensive than a plain text input. In other words, the processes to convert SPR data into ESPR data by the MPU 120 of FIG. 1 are less extensive. However, there still is a processing requirement of matching the lyrical text, which has been converted by the user to SPR, specifically to a given song so as to have a proper output.

In step 320, the SPR data is input through an input device 110 of FIG. 1. There are a variety of methods to input the SPR data, and the examples contained herein are not intended to limit the manner in which data is inputted. For example, a text document of SPR can be uploaded to the MPU 120 of FIG. 1. Also, the SPR can be keyed in through a synthesizer, keyboard, or another type of input device.

In step 330, musical data is input. There are a variety of methods to input the musical data, and the examples contained herein are not intended to limit the manner in which musical data is input. For example, the musical data can also be keyed in through a synthesizer, keyboard, or another type of input device.

In step 340, the musical data and the SPR are converted by an MPU 120 of FIG. 1. The musical data and the SPR is converted to ESPR data and tied to a channel. The desired vocalization may not necessarily have to singularly be tied (TYPO) to a channel. There can be a correlation between a given instrument and the vocalization, or there can be multiple vocalizations by different voices. Moreover, the vocalization does not necessarily have to be a single voice, but can represent a chorus of voices as well. In the most extreme case, the music file format can contain only the vocalizations as represented by ESPR, that is to say, an “a capella” performance of a single voice, multiple voices, or a chorus. Also, there can be a correlation between a given instrument channel and ESPR data when the ESPR data relies on the instrument channel to provide some of the performance information. Multiple sets of ESPR data (representing different voices) can be tied to the same or different instrument channels. Moreover, a set of ESPR data does not necessarily have to be a single voice, but a chorus of voices as well.

In step 350, the user is prompted to determine if the conversion to ESPR is complete. At this step, the user can make a variety of changes to the ESPR. For example, the user can change the singer. There are a variety of changes that can be made, and the examples contained herein are not intended to limit the manner in which the ESPR can be changed.

In step 360, the ESPR and other musical data are stored. There are a variety of file formats that can be utilized. For example, the MIDI file format can be used. Also, there are a variety of well-known methods to store the converted file with the ESPR data embedded. For example, an HDD can be utilized. Moreover, the MPU 120 of FIG. 1 can transfer information directly to storage (as shown), transfer though a communications network, or any combination of the two.

Now referring to FIG. 4 of the drawings, the reference numeral 400 generally designates a flow chart a method for embedding ESPR data into a music file.

The inputting of ESPR data need not be back-end intensive. In other words, little processing may be needed to simply embed the inputted ESPR data into a music file by the MPU 120 of FIG. 1. However direct entry of ESPR data, before entrance into an encoding system 100 of FIG. 1, is labor intensive and requires a knowledgeable user perhaps using additional programs and or processors.

In step 410, the ESPR format is input through an input device 110 of FIG. 1. There are a variety of methods to input the ESPR data, and the examples contained herein are not intended to limit the manner in which data is inputted. For example, a text document can be uploaded to the MPU 120 of FIG. 1. Also, the ESPR can be keyed in through a synthesizer, keyboard, or another type of input device.

In step 420, the user is prompted to determine if the conversion to ESPR is complete. At this step, the user can make a variety of changes to the ESPR. For example, the user can change the singer. There are a variety of changes that can be made, and the examples contained herein are not intended to limit the manner in which the ESPR can be changed.

In step 440, musical data is input if the ESPR is complete. There are a variety of methods to input the musical data, and the examples contained herein are not intended to limit the manner in which musical data is input. For example, the musical data can also be keyed in through a synthesizer, keyboard, or another type of input device.

In step 450, the musical data and the ESPR data are converted by an MPU 120 of FIG. 1. The musical data and the ESPR are embedded into the music format and tied to a channel. The desired vocalization may not necessarily have to singularly be tied to a channel. There can be a correlation between a given instrument and the vocalization, or there can be multiple vocalizations by different voices. Moreover, the vocalization does not necessarily have to be a single voice, but can represent a chorus of voices as well. In the most extreme case, the musical file format may contain only vocalizations as represented by the ESPR data, that is to say, an “a capella” performance of a single voice, multiple voices, or a chorus. Also, there can be a correlation between a given instrument channel and the ESPR data when the ESPR data relies on the instrument channel to provide some of the performance information. Multiple sets of ESPR data (representing different voices) can be tied to the same or different instrument channels. Moreover, a set of ESPR does not necessarily have to be a single voice, but a chorus of voices as well.

In step 460, the ESPR and other musical data are stored. There are a variety of file formats that can be utilized. For example, the MIDI file format can be used. Also, there are a variety of well-known methods to store the final file format with embedded the ESPR. For example, an HDD can be utilized. Moreover, the MPU 120 of FIG. 1 can transfer information directly to storage (as shown), transfer though a communications network, or any combination of the two.

It will further be understood from the foregoing description that various modifications and changes can be made in the preferred embodiment of the present invention without departing from its true spirit. This description is intended for purposes of illustration only and should not be construed in a limiting sense. The scope of this invention should be limited only by the language of the following claims.

1. An apparatus for generating enhanced phonetic data into a computer recognizable representation by a processor, comprising:
means for inputting linguistical data into the processor;
the processor for at least generating the enhanced data into a computer recognizable representation, wherein the processor further comprises:
an input port for receiving the linguistical data;
means for deriving phonetic representations of the linguistical data;
at least one control sequence, wherein the at least one control sequence at least provides associations between phonetic representations of the linguistical data and musical data to generate the enhanced phonetic data; and
means for storing of the computer recognizable file.

2. The apparatus of claim 1, wherein the linguistical data is plain text.

3. The apparatus of claim 1, wherein the linguistical data is symbolic phonetic representation (SPR).

4. The apparatus of claim 1, wherein the linguistical data is Enhanced SPR (ESPR).

5. A method for embedding enhanced phonetic data into a computer recognizable representation by a processor, comprising:
inputting linguistical data into the processor;
determining if the linguistical data is at least configured to have embedded phonetic representations;
if the linguistical data is at least configured to have embedded phonetic representations, deriving phonetic representations of the linguistical data;
providing associations between phonetic representations of the linguistical data and musical data to generate the enhanced phonetic data; and
storing the enhanced phonetic data as the computer recognizable file.

6. The apparatus of claim 5, wherein the linguistical data is plain text.

7. The apparatus of claim 5, wherein the linguistical data is symbolic phonetic representation (SPR).

8. The apparatus of claim 5, wherein the linguistical data is Enhanced SPR (ESPR).

9. A computer program product for embedding enhanced phonetic data into a computer recognizable representation by a processor, the computer program product having a medium with a computer program embodied thereon, the computer program comprising:
computer program code for inputting linguistical data into the processor;
computer program code for determining if the linguistical data is at least configured to have embedded phonetic representations;
if the linguistical data is at least configured to have embedded phonetic representations, computer program code for deriving phonetic representations of the linguistical data;
computer program code for providing associations between phonetic representations of the linguistical data and musical data to generate the enhanced phonetic data; and
computer program code for storing the enhanced phonetic data as the computer recognizable file.

10. The computer program code of claim 5, wherein the linguistical data is plain text.

11. The computer program code of claim 5, wherein the linguistical data is symbolic phonetic representation (SPR).

12. The computer program code of claim 5, wherein the linguistical data is Enhanced SPR (ESPR).

13. A processor for embedding enhanced phonetic data into a computer recognizable representation in a computer system, the processor including a computer program comprising:
computer program code for inputting linguistical data into the processor;
computer program code for determining if the linguistical data is at least configured to have embedded phonetic representations;
if the linguistical data is at least configured to have embedded phonetic representations, computer program code for deriving phonetic representations of the linguistical data;
computer program code for providing associations between phonetic representations of the linguistical data and musical data to generate the enhanced phonetic data; and
computer program code for storing the enhanced phonetic data as the computer recognizable file.

14. The computer program code of claim 5, wherein the linguistical data is plain text.

15. The computer program code of claim 5, wherein the linguistical data is symbolic phonetic representation (SPR).

16. The computer program code of claim 5, wherein the linguistical data is Enhanced SPR (ESPR).

17. A method for embedding enhanced phonetic data into a computer recognizable representation by a processor, comprising:
if inputted linguistical data is at least configured to have embedded phonetic representations, deriving phonetic representations of the linguistical data; and
providing associations between phonetic representations of the linguistical data and musical data to generate the enhanced phonetic data.

18. An apparatus for embedding enhanced phonetic data into a computer recognizable representation by a processor, comprising:
if inputted linguistical data is at least configured to have embedded phonetic representations, means for deriving phonetic representations of the linguistical data; and
means for providing associations between phonetic representations of the linguistical data and musical data to generate the enhanced phonetic data.
